(19) United States
(12) Patent Application Publication
(10) Pub. No.: US 2018/0108457 A1
(43) Pub. Date: Apr. 19, 2018

(54) Method of Depositing Niobium Doped Titania Film on a Substrate and the Coated Substrate Made Thereby

(71) Applicant: Vitro S.A.B. de C.V., Nuevo Leon (MX)

(72) Inventors: Ashtosh Ganjoo, Allison Park, PA (US); Songwi Lu, Wexford, PA (US); James W. McCamy, Export, PA (US); James J. Finley, Pittsburgh, PA (US)

(21) Appl. No.: 15/798,149

(22) Filed: Oct. 30, 2017

Related U.S. Application Data
(62) Division of application No. 14/047,324, filed on Oct. 7, 2013, now abandoned.
Application No. 14/047,324 is a continuation-in-part of application No. 12/767,910, filed on Apr. 27, 2010, now Pat. No. 8,551,609.

(51) Int. Cl. H01B 13/00; C03C 17/34; C03C 17/25; C03C 17/245; C03C 17/00

(52) U.S. Cl. CPC H01B 13/0036; C03C 2218/152; C03C 2218/112; C03C 2217/94; C03C 2217/24; C03C 2217/218; C03C 2217/212; C03C 17/3417; C03C 17/256; C03C 17/2456; C03C 17/002

(57) ABSTRACT

A coated article includes an applied transparent electrically conductive oxide film of niobium doped titanium oxide. The article can be made by using a coating mixture having a niobium precursor and a titanium precursor. The coating mixture is directed toward a heated substrate to decompose the coating mixture and to deposit a transparent electrically conductive niobium doped titanium oxide film on the surface of the heated substrate. In another coating process, the mixed precursors are moved toward the substrate positioned in a plasma area between spaced electrodes to coat the surface of the substrate. Optionally, the substrate can be heated or maintained at room temperature. The deposited niobium doped titanium oxide film has a sheet resistance greater than 1.2 ohms/square and an index of refraction of 1.00 or greater. The chemical formula for the niobium doped titanium oxide is Nb:TiOₓ where X is in the range of 1.8-2.1.

### RELATED APPLICATION

This application is a continuation-in-part application of U.S. patent application Ser. No. 12/767,910 titled A Method of Depositing Niobium Doped Titania Film on a Substrate and the Coated Substrate Made Thereby, filed on Apr. 27, 2010 In the names of Songwei Lu, James W. McCamy and James J. Finley. U.S. patent application Ser. No. 12/767,910 in its entirety is hereby incorporated by reference.

### BACKGROUND OF THE INVENTION

### Field of the Invention

This invention relates to a method of depositing a transparent electrically conductive niobium doped titania film on a substrate and the coated substrate made thereby, and more particularly, to applying the niobium doped titana film on or over the surface of a glass substrates by a chemical vapor deposition coating process to provide a coated substrate that can be used, in the manufacture of, but not limited to, photovoltaic devices, electrodes for electro chromic-devices, touch screen devices, electrically heatable vision panels for refrigerators and aircraft windows, organic light emitting diodes and low emissivity coatings for residential and commercial windows.

### DISCUSSION OF THE PRESENT TECHNOLOGY

Substrates, e.g. but not limited to, glass sheets having a transparent electrically conductive oxide film deposited on a surface are used in the manufacture of, but not limited to, thin film photovoltaic applications, electrical touch panels, electrodes for electro-chromic devices, organic light emitting diodes, electrically heated glass for anti-fog commercial refrigerator doors and for aircraft transparencies, and low emissivity coatings for residential and commercial windows, e.g. Infra-red reflective windows. Of particular interest in the present discussion are transparent electrically conductive oxide films deposited by a chemical vapor deposition coating process usually referred to in the art as the CVD process, e.g. but not limited to the CVD processes disclosed in U.S. Pat. Nos. 4,853,257; 5,356,718 and 7,413,767. One of the most common transparent electrically conductive oxide films, among other films, deposited on glass by the CVD process is a tin oxide film usually doped with fluorine.

Although fluorine doped tin oxide films are acceptable for making transparent electrically conductive and infra-red reflective coatings, it can be appreciated by those skilled in the art that having additional transparent electrically conductive oxide films or coatings available reduces the usage of tin and provides a more competitive market for purchases of material for use in the manufacture of transparent conductive oxide films by the chemical vapor deposition coating process.

### SUMMARY OF THE INVENTION

The invention relates to an improved coated article of the type having a deposited transparent electrically conductive oxide film over a surface of a substrate, the improvement includes, among other things, an atmospheric or a sub-atmospheric pressure chemical vapor deposition deposited transparent electrically conductive niobium doped titanium oxide film.

The invention further relates to a vaporized coating mixture for a coating process, the coating mixture includes, among other things, a vaporized precursor containing niobium, and a vaporized precursor containing titanium.

Still further the invention relates to improving a method of applying a transparent electrically conductive oxide film over a surface of a substrate, the method includes, among other things, directing a coating mixture toward the surface of a heated substrate to pyrolytically deposit a coating over a surface of the substrate. The improvement includes, among other things, selecting a coating process from a group of coating processes comprising atmospheric chemical vapor deposition coating process and negative pressure chemical vapor deposition coating process, and applying a niobium doped titanium oxide over the surface of the substrate.

### BRIEF DESCRIPTION OF THE DRAWINGS

FIG. 1 is a side elevated view of a coating apparatus used in the practice of the invention to apply or deposit a niobium doped titania film on a substrate.

FIG. 2 is a partial cross sectional side view of a glass forming chamber having chemical vapor deposition equipment that can be used in the practice of the invention to apply or deposit a niobium doped titania film on a substrate.

FIGS. 3-5 are side elevated partial views of coated glasses having, among other things, a niobium doped titania film applied or deposited in accordance to the invention.

FIG. 6 is a plan view of a coating side of a coater that can be used in the practice of the invention.

FIG. 7 is a partial cross sectional side view of a glass forming chamber and an annealing furnace with a pyrolytic coater between the exit end of the forming chamber and the entrance end of the annealing furnace; the arrangement can be used in the practice of the invention to apply or deposit a niobium doped titania film on a substrate.

FIG. 8 is a side view of a coater and glass sheet mounted for movement relative to one another in accordance to the teachings of the invention to apply or deposit a niobium doped titania film on a substrate.

FIG. 9 is a cross sectional view of a reactor that can be used in the practice of the invention to deposit a niobium doped titania film by plasma enhanced chemical vapor deposition.

### DETAILED DESCRIPTION OF THE INVENTION

As used herein, spatial or directional terms, such as “inner”, “outer”, “left”, “right”, “down”, “horizontal”, “vertical”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about.” Accordingly, unless indicated to the contrary, the numerical values set forth in the following specification and claims can vary depending upon the property desired and/or sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between and inclusive of the minimum value of 1 and the maximum value of 10; that is, all subranges beginning with a minimum value of 1 or more and ending with a maximum value of 10 or less, e.g., 1 to 6.7, or 3.2 to 8.1, or 5.6 to 10. Also, as used herein, the term “moved over” “coated over”, “applied over” and “positioned over” means moved, coated and positioned on but not necessarily in surface contact with. For example, a first film “coated over” a surface does not preclude the presence of a second film between the surface and the first film.

Before discussing several non-limiting embodiments of the invention, it is understood that the invention is not limited in its application to the details of the particular non-limiting embodiments shown and discussed herein since the invention is capable of other embodiments. Further, the terminology used herein to discuss the invention is for the purpose of description and is not of limitation. Still further, unless indicated otherwise, in the following discussion like numbers refer to like elements.

In the practice of the invention, a chemical vapor deposited coating process is practiced to deposit a film of titania (“TiO₂”) doped with niobium (“Nb”) (also referred to as a “TiO₂:Nb film”) over, or on, e.g. in surface contact with, a surface of a substrate. The TiO₂:Nb film is conductive and has an index of refraction greater than 1, e.g. but not limited to 2.3; the index of refraction of the coated article measured using an ellipsometer. As can now be appreciated, the invention is not limited to the stoichiometry of the formula TiO₂:Nb, e.g. the value of oxygen can be greater than or less than 2, e.g. but not limited to the range of 1.8-2.1.

In the non-limiting embodiments of the invention discussed below, for purposes of clarity and not limiting to the invention the chemical vapor deposition coating processes are divided into two groups, namely (1) atmospheric pressure chemical vapor deposition coating process and (2) sub-atmospheric pressure or negative pressure chemical vapor deposition coating process. The atmospheric pressure chemical vapor deposition coating process is a chemical vapor deposition coating process carried out in atmospheric pressure and heat (thermal). The heat provides the energy to decompose the precursor to give the coating. The atmospheric pressure chemical vapor deposition coating process is also referred to herein as the “APCVD coating process” or “APCVD. An APCVD coating process is disclosed in U.S. Pat. No. 5,356,718, which patent in its entirety is hereby incorporated by reference.

The sub-atmospheric pressure or negative pressure chemical vapor deposition coating process is a chemical vapor deposition coating process carried out in a sub-atmospheric pressure or negative pressure where negative pressure refers to the pressure of the process that is below standard atmospheric pressure. In the art, sub-atmospheric pressure or negative pressure chemical vapor deposition coating processes are also referred to as plasma chemical vapor deposition coating process or plasma enhanced chemical vapor deposition coating process. The plasma provides the energy to break down the precursors to give the coating. The sub-atmospheric pressure or negative pressure chemical vapor deposition coating processes are also referred to herein as “PECVD coating process” or “PECVD”. A PECVD coating process is disclosed in U.S. Pat. No. 6,333,079. As is appreciated, the invention is not limited to any particular APCVD or PECVD coating process, and any of the APCVD and PECVD coating processes known in the art can be used in the practice of the invention. Further any coating process known in the art, e.g. but not limited to, spray pyrolysis coating process can be used in the practice of the invention. Suitable spray pyrolysis methods and apparatuses are described in U.S. Pat. Nos. 3,660,061; 4,111,150; 4,719,126 and 4,719,127, which patents in their entirety are hereby incorporated by reference.

Substrates that can be used in the practice of the APCVD and the PECVD coating processes of the invention include, but are not limited to, to clear or colored glass, plastic or metal. Further, the substrates can have any shape, e.g. but not limited to bottles, flat substrates, curved substrates, circular shaped substrates, polygon shaped substrates.

Non-limiting embodiments of the invention include, but are not limited to, a TiO₂:Nb film over, or in surface contact with, a surface of a glass substrate; a TiO₂:Nb film over, or in surface contact with an anti-Iridescence, or color suppression layer including one or more coating films over, or in surface contact with, a surface of a glass substrate; a TiO₂:Nb film over, or in surface contact with, a layer of one or more transparent, translucent, opaque, coating films or combinations thereof, and a TiO₂:Nb film in surface contact with a sodium barrier over, or in surface contact with a surface of a glass substrate. As can be appreciate the TiO₂:Nb film of the invention can be under the anti-iridescence, or color suppression layer; under the layer of one or more transparent, translucent, opaque, coating films or combinations thereof; and under the sodium barrier. Further the TiO₂:Nb film of the invention can be under or over a film having an index of refraction value greater or less than the index of refraction value of the TiO₂:Nb film of the invention. Products that can be made with the coated glass substrate of the invention include, but are not limited to, coated glass for infra-red reflecting windows, thin film photovoltaic applications, electrical touch panels, display screens, electrodes for electro-chromic articles, organic light emitting diodes and electrically heated glass for anti-fog commercial refrigerator doors and for aircraft transparencies.

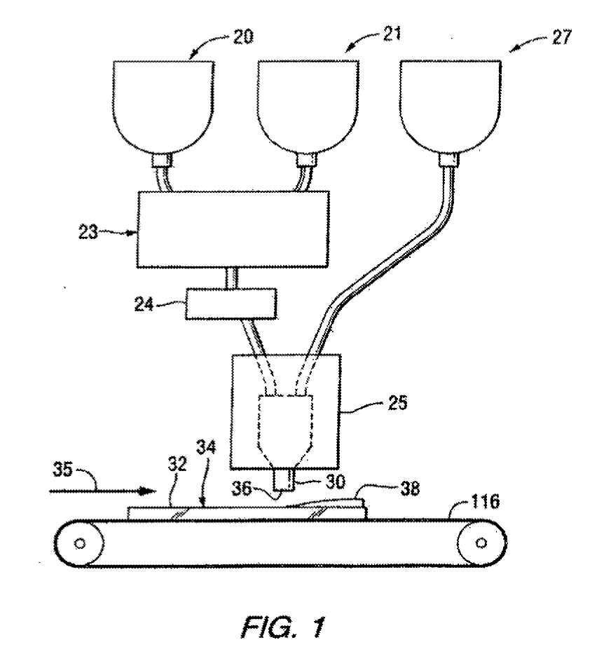

An experiment was conducted to deposit a conductive TiO₂:Nb film on or over a surface of a glass substrate using non-limited embodiments of the APCVD coating process of the invention. More particularly and with reference to FIG. 1, non-limiting embodiments of the invention were practiced to coat heated flat glass sheets using a niobium precursor of niobium ethoxide (Nb(C₂H₅O)₅) (hereinafter also referred to as “NbE”) and a titanium precursor of titanium tetraisopropoxide (Ti[OCH(CH₃)₂]₄) (hereinafter also referred to as “TPT”). The liquid NbE from NbE supply 20 and the liquid TPT from TPT supply 21 were continuously added to mixer 23. The NbE and TPT mixture was moved from the mixer 23 into a vaporizer 24 heated to a temperature of 300° Fahrenheit (“F”) (149° Centigrade (“C”)) to vaporize the NbE and TPT mixture. The vaporized NbE and TPT mixture was moved from the vaporizer 24 to a chamber 25 heated to a temperature of 300° F. (149° C.) and was mixed with nitrogen gas moved from supply 27 to the chamber 25. The vaporized mixture of NbE, TPT, and nitrogen gas was moved out of the chamber 25 to, and through, a coating nozzle 30 toward a surface 32 of a glass sheet 34 heated to a temperature of about 115° F. (521° C.) and moving in the direction of arrow 35 under opening 36 of the coating nozzle 30 to deposit or apply a TiO₂:Nb film 38 on the surface 32 of the glass sheet 34.

The glass sheets had a length of 12 to 36 inches (30.5 to 91.4 centimeters (“cm”)) and a width of 12 inches (30.5 cm) and were moved at a at a rate of 5 Inches per minute (12.7 cm per minute). The opening 36 of the coating nozzle 30 was an elongated opening having a width of 1/16 to ⅛ Inches (0.16 0.32 cm) and a length of 12 inches (30.5 cm). The NbE liquid precursor was moved at a rate of 0 to 8 milliliters per hour (“ml/h”), into the mixer 23, and the TPT liquid precursor was moved at a rate of 24-28 ml/h, into the mixer 23. The Table below provides the specific flow rates of the NbE liquid precursor and the TPT liquid precursor for coating runs 1-8.

TABLE
Flow Rate (ml/h)

| Coating Run | TPT liquid precursor | NbE liquid precursor |
|---|---|---|
| 1 | 28 | 0 |
| 2 | 24 | 2 |
| 3 | 24 | 4 |
| 4 | 24 | 6 |
| 5 | 25 | 0 |
| 6 | 25 | 2 |
| 7 | 25 | 4 |
| 8 | 25 | 6 |

The NbE liquid precursor had a zero flow rate for coating Runs 1 and 5 to establish the TiO₂ baseline or control. More particularly, the TiO₂ film is electrically non-conductive, therefore, if the coatings of the samples of the Runs 2 to 4, and the Runs 6 to 8, are electrically conductive, it is concluded that an electrically conductive TiO₂:Nb film can be deposited by the chemical vapor deposition coating processes.

The NbE and TPT liquid mixture was moved out of the mixer 23 into the vaporizer 24 at a flow rate of 12 ml/h. The nitrogen and the vaporized mixture of NbE and TPT were moved into the chamber 25 at a rate of 35 standard liters per minute (‘slm’). The mixed coating vapor of NbE, TPT and N2 was moved out of the coating nozzle opening 36 toward the surface 32 of the glass sheet 34 at a rate of 35 slm.

The TiO₂:Nb film 38 deposited on the surface 32 of the glass sheet 34 had a thickness of 200 nm to 2 um thick. The film 38 had varying colors, which is characteristic of a film having non-uniform thickness. In a few areas of the film 38 of the Runs 2-4 and 6-8, the sheet resistance was 1.2 to 3.2 ohms/square, and in other areas of the film, the sheet resistance was higher.

As can now be appreciated, the above work demonstrates that a TiO₂:Nb film can be applied by the APCVD coating process on or over the surface of a heated substrate, e.g. the surface 32 of the glass sheet 34. Another feature of the deposited TiO₂:Nb film is that it has a an index of refraction higher than the index of refraction of the fluorine doped tin oxide film, e.g. the index of refraction of the TiO₂:Nb film is greater than 1, e.g. 2.3, whereas the index of refraction of the fluorine doped tin oxide is 2.00.

As can be appreciated, the invention is not limited to the niobium precursor or the titanium precursor used in this example, and any available niobium and/or titanium precursors in either liquid, gaseous or solid form at room temperature can be used in the practice of the invention to provide the mixed vaporized coating of niobium and titanium precursors and a carrier gas for use in a APCVD coating process, or a mixed liquid coating of niobium and titanium precursors for use in a pyrolytic spray coating process, to apply or deposit the niobium doped titania transparent conductive oxide film of the invention to a surface of a substrate, e.g. but not limiting to the invention to the surface 32 of the glass sheet 34. Niobium precursors that can be used in the practice of the invention, include but are not limited to, niobium ethoxide, niobium V n-butoxide, tetrakis(2,2,6,6-tetramethyl-3, 5-heptanedionato)niobium(IV) and niobium 2-ethylhexanoate. Titanium precursors that can be used in the practice of the invention, include, but are not limited to titanium tetraisopropoxide (TPT), titanium tetrachloride, titanium(IV) ethoxide, titanium(IV) n-butoxide, titanium(IV) methoxide, tetrakis(diethylamino) titanium, titanium(IV) t-butoxide and titanium(IV) bis(ethyl acetoacetato)diisopropoxide. Further, the invention is not limited to the carrier gas, and any carrier gas known in the art for use with liquid and vapor precursors and is in the gaseous state at the temperature inside the chamber 25 can be used in the practice of the invention and include, but are not limited to nitrogen, helium, argon, xenon, air, oxygen and combinations thereof.

Further, as can be appreciated, the invention is not limited to the temperature of the vaporized mixed precursors and carrier gas as they move into the chamber 25, and to the temperature of the vaporized coating, e.g. the vaporized precursors and carrier gas, as it exits the opening 36 of the coating nozzle 30; however, in the practice of the invention, it is preferred that the temperature of the vaporized coating is sufficiently high to have the coating in the vapor state, but is below the decomposition temperature of the precursors.

The invention is not limited to the flow rate of the liquid niobium precursor, and of the liquid titanium precursor moving into the mixer 23 (see FIG. 1) and the flow rates of the liquid niobium precursor, and of the liquid titanium precursor can be the same or different. However, varying the flow rate of the liquid precursors as they move into the mixer 23, will vary the ratio of niobium to titania in the coated film 38. For example and not limiting to the discussion, increasing the flow rate of the liquid niobium precursor relative to that of the liquid titanium precursor increases the amount of niobium in the film, and increasing the flow rate of the liquid titanium precursor relative to that of the liquid niobium precursor increases the amount of titanium in the film.

Within the preferred range of conditions, increasing the flow rate of the vaporized coating out of the nozzle 30 while keeping the speed of the glass sheet 34 constant, or decreasing the speed of the glass sheet while keeping the flow rate of the vaporized coating out of nozzle 30 constant, increases the thickness of the film 38. And, within the preferred range of conditions, decreasing the flow rate of the vaporized coating out of the nozzle 30 while keeping the substrate speed constant, or increasing the substrate speed while keeping the flow rate of the vaporized coating out of the nozzle constant, decreases the thickness of the film 38. As can now be appreciated, adjusting the glass sheet speed and/or the flow rate of the vaporized coating out of the coating nozzle 30 can be used to obtain a TiO₂:Nb film of a desired thickness and desired ratio of titanium to niobium.

The invention is not limited to the configuration of the opening 36 of the nozzle 30, and the nozzle opening 36 can have an elongated shape, a circular shape, or a polygon shape, and the size of the opening 36 of the coating nozzle 30 can have any dimension. As is appreciated by those skilled in the art of APCVD coating process the nozzle configuration and size of the nozzle opening is selected to deposit a TiO₂:Nb film on a flat or contoured surface of a heated substrate, e.g. a glass sheet 34.

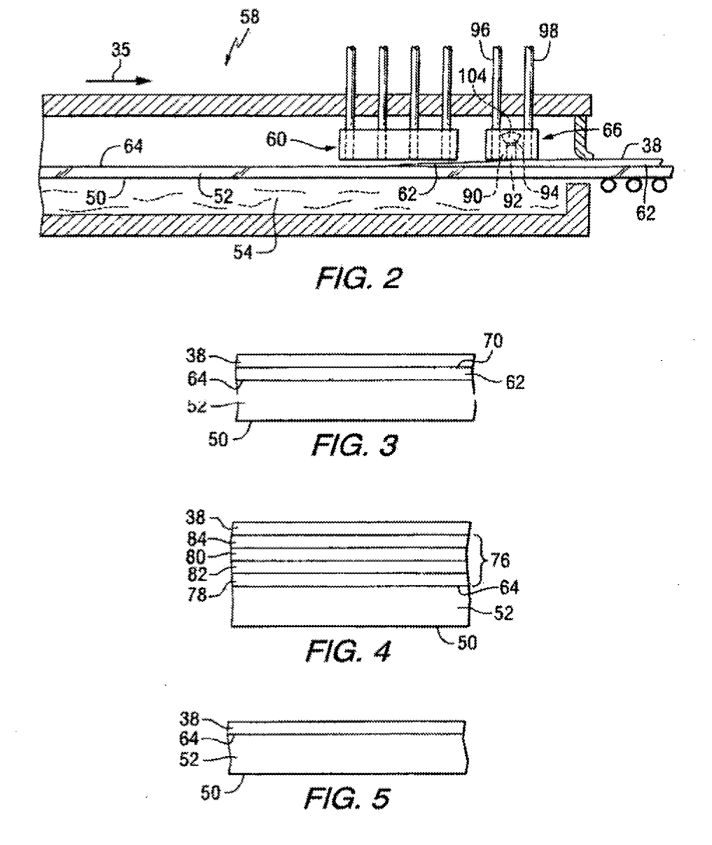

The discussion is now directed to practicing the invention to apply the TiO₂:Nb transparent electrically conductive oxide film of the invention over, or in surface contact with, a surface of a continuous glass ribbon. With reference to FIG. 2, in one non-limiting embodiment of the invention, surface 50 of a continuous glass ribbon 52 floats on a pool 54 of molten metal and moves in the direction of arrow 35. The pool 54 of molten metal is contained in a glass-forming chamber 58, e.g. but not limited to the type disclosed in U.S. Pat. Nos. 3,333,936 and 4,402,722, which patents are hereby incorporated by reference. As the glass ribbon 52 moves under APCVD coater 60, e.g. first APCVD coater, an anti-iridescence, or color suppression film 62 is applied to surface 64 of the glass ribbon 52, e.g. in surface contact with the surface 64 of the glass ribbon 52 as shown in FIG. 3. Continued movement of the glass ribbon 52 in the direction of arrow 35 moves the glass ribbon 52 under CVD coater 66, e.g. second CVD coater to apply the TiO₂:Nb film 38 of the invention (see FIG. 2) onto surface 70 of the film 62.

The anti-iridescence, or color suppression film 62 is not limiting to the invention and can be a gradient layer of mixed metal oxides having different index of refraction, e.g. but not limited to the type disclosed in U.S. Pat. Nos. 5,356,718 and 5,863,337, which patents are hereby incorporated by reference. In general, the percent of one metal oxide in the anti-iridescence or color suppression film 62 decreases as the distance from the surface 64 of the glass ribbon 52 increases to provide a gradient anti-iridescence film 62 having 100% of the metal oxide having a lower index of refraction, e.g. silicon oxide at the surface 64 of the glass ribbon 52, and 100% of the metal oxide having the higher index of refraction, e.g. tin oxide at the surface 70 of the anti-iridescence film 62 (see FIG. 3). For a detailed discussion of the chemistry and application of an anti-iridescence film references can be made to U.S. Pat. Nos. 5,356,718, 5,863,337 and 7,431,992 B2, which patents are hereby incorporated by reference.

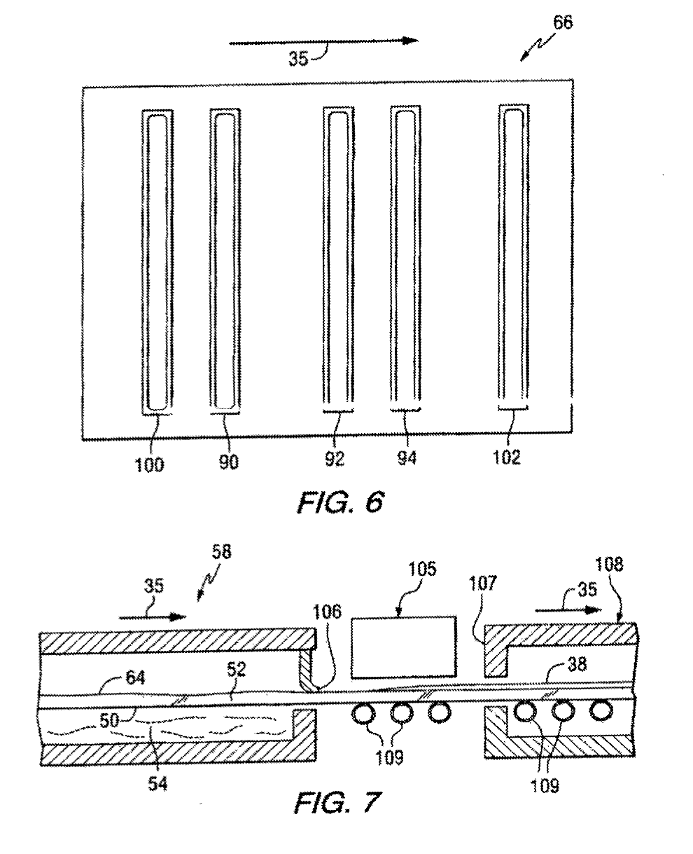

The invention further contemplates an anti-iridescence or color suppression layer having two or more homogeneous layers of metal oxides, e.g. silicon oxide and tin oxide having different index of refraction. More particularly and not limiting to the invention, shown in FIG. 4 is an anti-iridescence or color suppression layer 78 having films of metal oxide 78 and 80 having the lower index of refraction alternating with films 82 and 84 of the metal oxide having the higher index of refraction. For a detailed discussion of anti-iridescence layers having a plurality of homogeneous layers of different metal oxides reference can be made to U.S. patent application Ser. No. 09/434,823 filed Nov. 5, 1999 and Australian Patent No. 758,267, which patent application and patent are hereby incorporated by reference. In one non-limited embodiment of the invention, the anti-iridescence or color suppression layer has two or more layers of metal oxides e.g., tin oxide and metal nitrides e.g., silicon nitride or a combination thereof such that the index profile through the color suppression layer can be tailored in a manner to engineer the transmitted and reflected spectrum of the full coating stack (i.e., color suppression layer and TiO₂:Nb).

Optionally, the anti-iridescence film 62 and the anti-iridescence layer 76 can be omitted, and the Nb:TiO₂ film 68 can be applied directly to the surface 64 of the glass ribbon 52 as shown in FIG. 5. In a non-limiting embodiment of the invention, the layer 62 is a sodium barrier, for example and not limiting to the discussion a homogenous, or non-homogenous or gradient layer of oxides of aluminum and silicon. In another embodiment of the invention, a film having an index of refraction less than the index of refraction is applied under or over the Nb:TiO₂ film 68, in still another non-limiting embodiment of the invention, a film having an index of refraction higher than the index of refraction of the Nb:TiO₂ film is applied over or under the Nb:TiO₂ film.

With reference to FIG. 2, the APCVD coating apparatus 60 for applying the gradient anti-iridescence, color suppression or sodium barrier film 62 (see FIG. 3), or multi-layer non-gradient anti-iridescence, color suppression, or sodium barrier layer 76 (see FIG. 4) is not limiting to the invention and any type of APCVD coating apparatus known in the art, e.g. but not limiting to the invention, the coating apparatus disclosed in U.S. patent application Ser. No. 12/572,317 filed on Oct. 2, 2009 in the names of James W. McCamy and John F. Sopko and titled NON-ORTHOGONAL COATER GEOMETRY FOR IMPROVED COATINGS ON A SUBSTRATE can be used in the practice of the invention to deposit the film 62 (see FIG. 3) and the layer 76 (see FIG. 4). The disclosure of U.S. patent application Ser. No. 12/572,317 filed on Oct. 2, 2009 is hereby incorporated by reference.

The APCVD coating apparatus 66 for depositing the TiO₂:Nb film is not limiting to the invention and any type of ACVD coating apparatus known in the art for applying a transparent electrically conductive oxide film over, or in surface contact with, a surface of a substrate, e.g. as disclosed in U.S. patent application Ser. No. 12/572,317 filed on Oct. 2, 2009, can be used in the practice of the invention. With reference to FIGS. 2 and 6 as needed, in one non-limiting embodiment of the invention, the coating apparatus 68 for applying the TiO₂:Nb film to, or over, the surface 64 of the glass ribbon 52 moving in the direction of the arrow 35 includes exhaust slot 90 upstream of coating nozzle 92, and exhaust slot 94 downstream of the coating nozzle 92. The effluent stream from the exhaust slots 90 and 94 are moved through conduits 96 and 98 (see FIG. 2), to a disposal area and processed in accordance with local, state and federal environmental regulations. The coating apparatus 66 further includes a gas curtain nozzle 100 upstream of the upstream exhaust slot 90, and a gas curtain nozzle 102 downstream of the downstream exhaust slot 94. An inert gas, e.g. nitrogen is moved through the gas curtain nozzles 100 and 102 to provide an inert gas barrier or curtain to prevent or limit the movement of the coating vapors or gases from the coating nozzle 92 from moving into the atmosphere of the glass-forming chamber 58, and to prevent or limit movement of the atmosphere of the glass-forming chamber into the space between the coater 66 and the surface 64 of the glass ribbon 52.

In one non-limiting embodiment of the invention, as the glass ribbon 62 moves under the coater 60, the anti-iridescence film 62 or the anti-iridescence layer 76 (see FIGS. 3 and 4) is applied on the surface 64 of the glass ribbon 52. As the glass ribbon 52 moves under the coater 66, the vaporized coating mixture including vaporized precursor containing niobium, a vaporized precursor containing titanium and nitrogen in chamber 104 of the coater 66 moves through the coating nozzle 92 to apply or deposit the TiO₂:Nb film 68 over the anti-iridescence film 52 or the anti-iridescence layer 76 as discussed above. The coating vapors, the reaction vapors and gases are removed from the coating area of the coating nozzle 92 by the exhaust slots 90 and 94 (see FIG. 5).

In another non-limiting embodiment of the invention, the coater 60 for applying the anti-Iridescence film 62 or the anti-Iridescence layer 76 is shut down, and the glass ribbon 52 moves under the coater 66 to apply the TiO₂:Nb film on the surface 64 of the glass substrate 50 (FIG. 5) as discussed above.

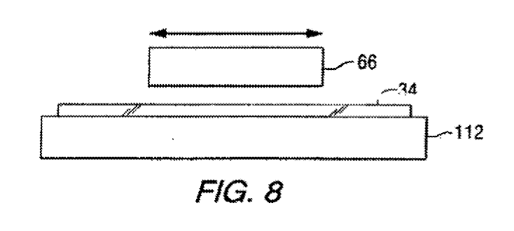

With reference to FIG. 7, in another non-limited embodiment of the invention, the TiO₂:Nb film 38 is applied by the spray pyrolytic coating process, e.g. as disclosed in U.S. Pat. Nos. 3,660,061; 4,111,150; 4,719,126 and 4,719,127, which patents are hereby incorporated by reference. As shown in FIG. 7, a spray pyrolysis coater 105 is mounted between exit end 106 of the glass forming chamber 58 and entrance end 107 of an annealing furnace 108. As the glass ribbon 52 is advanced by the conveyor rolls 109 in the direction of the arrow 35, the glass ribbon 52 passes under the coater 105 to deposit the TiO₂:Nb film on the surface 64 of the glass ribbon 52, and thereafter, the coated glass ribbon is moved by the conveyor rolls 109 into the annealing furnace 108. As can now be appreciated, the invention is not limited to placing the coater 105 at the exit end 106 of a glass forming chamber 58, and the coater for applying the TiO₂:Nb film can also be located at the exit end of any furnace, e.g. but not limited to a roller hearth or an oscillating hearth, that heats glass for applying a coating, for shaping, and/or for tempering or heat strengthening the glass. Still further, with reference to FIG. 8, the invention contemplates coating the glass sheet 34 mounted on a stationary table 112 in any convenient manner, and the coater, e.g. but not limiting to the discussion the coater 66 moved over the sheet 34. The invention further contemplates securing the coater 66 in position and moving the sheet 34 on conveyor belt 116 under the coater 66. The invention also contemplates simultaneously moving the coater 66 and the glass sheet 34. Systems for moving glass sheets and/or coaters, and for maintaining coaters and/or glass sheets stationary are will known in the art and no further discussion regarding such systems is deemed necessary.

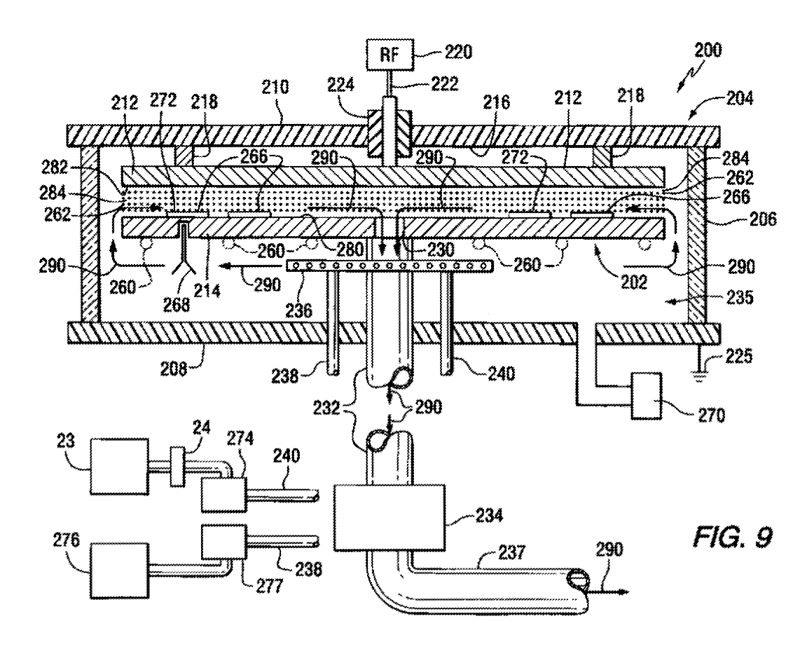

Consider now depositing the TiO₂:Nb film using the plasma enhanced chemical vapor deposition (“PECVD”) coating process. Plasma enhanced chemical vapor deposition and apparatuses for the practice of PECVD are well known in the art, e.g. are discussed in, but not limited to, U.S. Pat. No. 6,333,079 B1. Shown in FIG. 9 is a non-limiting embodiment of a plasma enhanced chemical vapor deposition reactor or a coating system designated by the number 200 that can be used in the practice of the invention to deposit the TiO₂:Nib film.

With reference to FIG. 9 the coating system 200 includes a plasma enhanced energy coating vapor deposition apparatus 202 mounted in a sealed chamber 204. Side wall 206 of the sealed chamber 204 is made of an electrically insulating material, and the side wall 206, and bottom wall 208 and top wall 210 of the sealed chamber 204 are made of a material that can be used to contain a low pressure, below the atmospheric pressure. In one non-limited embodiment of the invention, a part of the side wall 206 is a circular wall made of glass, e.g. Pyrex glass, and the bottom wall 208 and the top wall 210 are made of metal.

The coating apparatus 202 includes a pair of metal electrodes 212 and 214 that are operated in the manner discussed below to provide a plasma between the electrodes 212 and 214. The electrode 212 is a high-frequency electrode and the electrode 214 is a passive electrode. The high-frequency electrode 212 is mounted to, and spaced from inner surface 216 of the top wall 210 by electrically non-conductive, e.g. plastic fasteners 218. The high frequency electrode 210 is connected to a radio frequency (“RF”) power source 220 by cable 222. The cable 222 passes through the top wall 210 and is spaced from the top wall 210 by an electrically insulating hollow plug 224. The passive electrode 214 is connected in any convenient manner to ground 225.

The passive electrode 214 has a center opening 230 and is mounted on a hollow metal tube 232. The tube 232 passes through the bottom wall 208 of the chamber 204, is sealed thereto in any convenient manner, and is connected to a purging system 234, which is connected to a gas exhaust system 235 to pull the gaseous atmosphere from interior 235 of the sealed chamber 204, through the hole 230 in the passive electrode 214 and through the tube 232 to a disposal area and processed in accordance with local, state and federal environmental regulations. With this arrangement flow of the vaporized precursor can be maintained over the substrate while a negative pressure can be maintained in a controlled manner within the sealed chamber 204. A gas ring 236 having a pair of gas inlet pipes 238 and 240 surrounds the tube 232 and is positioned between the passive electrode 214 and the bottom wall 208 of the sealed chamber 204. As described in more detail below, the gas ring 236 inputs gas into the interior 235 of the sealed chamber 204, and the gases in the chamber 204 are moved out of the chamber 204 by way of the hole 230 in the passive electrode 214 and the tube 232.

With continued reference to FIG. 9, heating coils 260 shown in phantom in FIG. 9 can be used to heat the passive electrode 214 to heat substrates 266 positioned on the passive electrode 214 as shown in FIG. 9. A thermocouple 268 for measuring the temperature of the passive electrode 214 is provided when the heating coils 260 are used. In this non-limiting embodiment of the invention, the heating coils 260 are not used. Further, in this non-limiting embodiment of the invention, the substrate 266 is a glass substrate, however, the invention, as discussed above is not limited thereto and the substrate can be made of any material compatible with the coating process, e.g. but not limited to metal, plastic, glass, wood and combinations thereof. The invention is not limited to the films of the coating stack applied to the glass substrate 266, and the coating stacks shown in FIGS. 3-5 can be applied to the substrate 266, and the TiO₂;Nb film 38 can be applied on or over the coating stack or glass substrate 266 using the PECVD coating process. A pressure gauge 270 to measure the pressure in the sealed chamber 204 is provided, but is not limiting to the invention. The precursors discussed above for applying the TiO₂:Nb film to a glass ribbon 50 are used in the practice of the invention to apply a TiO₂:Nb film on or over surface 272 of the glass substrate 266 using PECVD coating process.

The discussion is now directed to using the reactor 200 to apply a TiO₂:Nb film over the surface 272 of the glass substrate 266. In this non-limited embodiment of the invention, the niobium precursor is NbE and the titanium precursor is TPT. The ratio of NbE to TPT (NbE/TPT) is in the range of zero to 0.8, and more preferably in the range of greater than zero to 0.5. The NbE and the TPT are mixed in the mixer 23 and passed to the vaporizer 24. In one preferred embodiment, if the boiling temperatures of the precursors have a difference of 50% or more, or the chosen temperature of the vaporizer is such that the vapor pressure of the two precursors are substantially different the precursors are vaporized separately and the vapors mixed. Precursors having significantly different boiling temperatures are added separately so that the precursor with the lower boiling temperature does not decompose before the vaporization of the precursor with the higher boiling temperature. The boiling points of NbE and TPT have a 10% difference and are mixed before being vaporized. More particularly, NbE has a boiling temperature of 220° F. and the TPT has a boiling temperature of 200° F., and the precursors have a boiling point difference of 10% ((220° F.-200° F.)/200° F.=10%). Optionally the NbE and TPT can be supplied to the vaporizer 23 separately.

The vaporized mixed precursors are passed to a mass flow controller 274 connected to the inlet pipe 240 of the gas ring 236. The reaction gases used in this non-limited embodiment of the invention are argon and oxygen; the invention, however, is not limited thereto and other reaction gases, e.g. nitrogen can be used. The ratio of reaction gases of argon to oxygen (O₂/Ar) is 3 to 6, e.g. 1500 standard cubic centimeters per minute (“SCCM”) of oxygen to 300 SCCM of argon. The reaction gases are moved from supply 276 to mass flow controller 277, and from the mass flow controller 277 to the inlet pipe 238 to the gas ring 236.

In a non-limiting embodiment of the invention, the RF source 220, the mass flow controllers 274 and 277, and the gas pumping system 234 are switched off. The top wall 210 of the reactor 200 is removed, and 4 glass substrate 266 are place on surface 280 of the passive electrode 214. The top wall 210 is secured on the wall 206 of the reactor 200 and sealed thereto to provide the sealed chamber 204. The surface 280 of the electrode 214 is in facing relationship to surface 282 of the electrode 212, and the surfaces 280 and 282 of the electrodes 214 and 212, respectively are spaced from one another to accept the thickness of the substrate 266 to proved a space 284 for the plasma 260 to form when the electrode 214 is energized.

The pump system 234 is energized to pull a vacuum of 10⁻⁶ to 10⁻⁷ Torr. The mass flow distributor 277 is energized to move the reactive gases through the gas ring 236 into the chamber 204, and the power supply 220 is energized. The gas pumping system 234 is operated to pull a vacuum of 10⁻⁴ to 10⁻² Torr. Energizing the power supply 220 causes the space 284 between the surfaces 280 and 282 of the electrodes 214 and 212, respectively to fill with plasma 262. More particularly, the plasma 262 is caused to take place by the aid of an electric field determined by electrostatic capacitance exhibited between the electrodes 212 and 214. Once plasma has taken place, a plasma region which is substantially a conductor and a sheath which acts chiefly as a capacitor in an equivalent manner between the plasma 262 and the electrodes 212 and 214 provide an impedance greatly different from that before the plasma takes place

After the plasma 262 forms between the electrodes 212 and 214, the mass flow controller 274 is energized to move the vaporized mixed precursors through the gas ring 236 into the sealed chamber 204 to mix with the plasma to coat the surface 272 of the substrates 266. During the coating of the substrates 266 the sealed chamber 204 is maintained at a pressure in the range of 10⁴ to 10⁻² Torr by controlling the pumping system 234 and the output of the mass controllers 274 and 277. During the coating process, the reaction gas is decomposed and excited by the plasma to form a deposited film 38 of TiO₂:Nb on the surface 272 of the substrates 266.

During the coating of the glass substrates 266, it is common to use a high-frequency power of 13.56 MHz. Use of such a discharge frequency of 13.56 MHz makes it relatively easy to control discharge conditions and brings about an advantage that the film 38 formed can have a good film quality, but may result in a low gas utilization efficiency and a relatively small deposited-film formation rate. The precursor gases are decomposed and excited by plasma to form a deposited film on the film-forming substrate 206. It is common to use a high-frequency power of 13.56 MHz.

The coating process is shut down by turning off the mass flow controller 274 to stop the flow of the precursors into the sealed chamber 204. The power supply 220 is turned off, followed by turning off the reaction and finally turning off the pumping system 234. Nitrogen is moved into the chamber until the sealed chamber reaches atmospheric pressure, after which the mass controller 277 is turned off, the top wall 210 is removed and the coated substrates removed from the chamber 204.

The thickness of the TiO₂:Nb film is not limiting to the invention and the thickness can be the same thickness as the films of the coated articles of FIGS. 3-5, and the coating stacks shown in FIG. 3-5 can be made. The thickness of the TiO₂:Nb film in the PECVD coating process is controlled by, among other things, the power input to the power supply 220, e.g. Increasing the power increases the film thickness; coating time, e.g. Increase the coating time increases the film thickness, energizing the heaters 260, e.g. increasing the heat increases the film thickness, and changing the flow of the reaction gases and the precursors, e.g. increasing the flow of the reaction gases and the precursors increases the coating thickness. In one non-limited embodiment of the invention the TiO2:Nb film has a thickness in the range of 10 nm to 2 um.

As related above, the gaseous precursors can be decomposed and excited using a high frequency, e.g. but not limiting to the invention greater than 1 MHz RF source. In additional embodiments of the invention, the PECVD coating system can be configured into a diode system or a triode system. In general and with reference to FIG. 9, in the diode PECVD system, the passive electrode 214 and the glass substrates 266 supported on the electrode 214 are connected to electrical ground. The high frequency electrode of the diode system is connected to the power source 220, and is designed to act as a gas diffusing showerhead to pass the gaseous precursors into the chamber 204 toward the substrates 266 supported on the passive electrode 214. Having the passive electrode 214 and the substrates 266 connected to the electrical ground allows the plasma 284 to be formed between them. This configuration provides for decomposition and excitation of the gaseous precursor. The triode PECVD coating system includes the diode PECVD system modified by adding a second RF source. More particularly, a grid connected to ground is provided between the passive electrode and the electrode of the diode PECVD coating system to act as gaseous precursor to apply a second bias to the substrate. When this frequency is substantially lower (less than 1 MHz and typically 360 kHz) then the excited ions in the plasma can be accelerated towards the substrate. This results in a higher film growth rate and the film density and morphology can be controlled. As is appreciated by those skilled in the art, diode and triode PECVD coating systems are known in the art and no further discussion is deemed necessary.

As can be appreciated by those skilled in the art, the characteristics of a chemical vapor deposited coating are durability, surface morphology, such as smoothness, functional property such as conductivity, and optical property, such as transmission, reflection, color, and haze.

It will be readily appreciated by those skilled in the art that modifications can be made to the non-limiting embodiments of the invention without departing from the concepts disclosed in the foregoing description. Accordingly, the particular non-limiting embodiments of the invention described in detail herein are illustrative only and are not limiting to the scope of the invention, which is to be given the full breadth of the appended claims and any and all equivalents thereof.

1-22. (canceled)

23. A vaporized coating mixture for a coating process, the coating mixture comprising:
a vaporized precursor containing niobium;
a vaporized precursor containing titanium,
wherein the coating process is a plasma negative atmosphere chemical vapor deposition coating process comprising a carrier gas, and wherein the niobium precursor is selected from the group of niobium ethoxide, niobium V n-butoxide, tetrakis(2,2,6,6-tetramethyl-3, 5-heptanedionato)niobium(IV), niobium 2-ethylhexanoate and combinations thereof.

24. The vaporized coating mixture according to claim 23, wherein the titanium precursor is selected from the group of titanium tetraisopropoxide (TPT), titanium tetrachloride, titanium(IV) ethoxide, titanium(IV) n-butoxide, titanium(IV) methoxide, tetrakis(diethylamino) titanium, titanium(IV) t-butoxide, titanium(IV) bis(ethyl acetoacetato)diisopropoxide and combinations thereof.

25. The vaporized coating mixture according to claim 23, wherein the carrier gas is selected from the group of nitrogen, helium, argon, xenon, air, oxygen and combinations thereof.

26. The vaporized coating mixture according to claim 23, wherein the niobium precursor is niobium ethoxide; the titanium precursor is titanium tetraisopropoxide, and the carrier gas is nitrogen.

27. The vaporized coating mixture according to claim 23 wherein the coating process is a negative pressure chemical vapor deposition coating process and comprises one or more reaction gases.

28. The vaporized coating mixture according to claim 26, wherein the coating process is a plasma enhanced chemical vapor deposition coating process.

29. The method according to claim 27 wherein the niobium doped titanium oxide film has sheet resistance greater than 1.2 ohms/square and an index of refraction of 1 or greater.

30. The vaporized coating mixture according to claim 28 wherein the chemical formula for the niobium doped titanium oxide is Nb:TiOₓ where X is in the range of 1.8-2.1.

31. The vaporized coating mixture according to claim 23 wherein the coating mixture is the negative pressure chemical vapor deposition coating process and the negative pressure chemical vapor deposition coating process is a plasma enhanced chemical vapor deposition coating process, and comprises:
moving a vaporized mixture of a titanium precursor and a niobium precursor into a sealed chamber having a negative pressure to mix the vaporized mixture with a plasma contained in the chamber to coat the surface of a substrate.

32. The vaporized coating mixture according to claim 31 further comprising depositing an intermediate coating layer on the surface of the substrate, and depositing the transparent electrically conductive niobium doped titanium oxide film on the intermediate coating layer.

33. The vaporized coating mixture according to claim 23 wherein the niobium precursor is selected from the group of niobium ethoxide, niobium V n-butoxide, tetrakis (2,2,6,6-tetramethyl-3, 5-heptanedionato)niobium(IV), niobium 2-ethylhexanoate and combinations thereof, and the titanium precursor is selected from the group of titanium tetraisopropoxide (TPT), titanium tetrachloride, titanium(IV) ethoxide, titanium(IV) n-butoxide, titanium(IV) methoxide, tetrakis(diethylamino) titanium, titanium(IV) t-butoxide, titanium(IV) bis(ethyl cetoacetato)diisopropoxide and combinations thereof.

34. The vaporized coating mixture according to claim 31 wherein the plasma is contained in an area between a pair of spaced electrodes.

35. The vaporized coating mixture according to claim 34 wherein electrical configuration is such that excitation RF source and the substrate are in a diode configuration.

36. The vaporized coating mixture according to claim 34 wherein the electrical configuration is such that the excitation RF source and an acceleration RF source and the substrate are in a triode configuration.

37. A substrate coated according to the vaporized coating mixture of claim 34.
